(19) United States
(12) Patent Application Publication
(10) Pub. No.: US 2012/0088444 A1
(43) Pub. Date: Apr. 12, 2012

(54) MOTOR VEHICLE

(75) Inventor: Marten WITTORF, Ingelheim (DE)

(73) Assignee: GM GLOBAL TECHNOLOGY OPERATIONS LLC, Detroit, MI (US)

(21) Appl. No.: 13/253,109

(22) Filed: Oct. 5, 2011

(30) Foreign Application Priority Data
Oct. 6, 2010 (DE) 102010047626.9

(51) Int. Cl. B60H 1/26; B60R 7/00

(52) U.S. Cl. 454/142; 296/24.34

(57) ABSTRACT

A motor vehicle is provided having a ventilation system. The ventilation system includes, but is not limited to at least one front ventilation opening for supplying air to a passenger on a front seat, a rear ventilation opening for supplying air to a passenger on a rear seat, an air duct for conducting air to the rear ventilation opening, the air duct being situated between the front seats in the area of a central console, the air duct being integrated in a removable central console part.

### CROSS-REFERENCE TO RELATED APPLICATION

This application claims priority to German Patent Application No. 10 2010 047 626.9, filed Oct. 6, 2010, which is incorporated herein by reference in its entirety.

### TECHNICAL FIELD

The technical field relates to a motor vehicle having a ventilation system.

### BACKGROUND

In motor vehicles, air is supplied to the interior of the motor vehicle through ventilation openings. The air supplied to the vehicle interior is cooled and/or heated in a motor vehicle air conditioner and supplied to the passengers on front seats through front ventilation openings and passengers or occupants on the rear seats through rear ventilation opening.

The motor vehicle air conditioner is generally located between the two front seats below the dashboard, so that the air for the rear ventilation opening must be conducted through an air duct from the front area of the motor vehicle having the motor vehicle air conditioner to the rear ventilation opening at the rear seats of the motor vehicle. The air to the rear seats can also be conducted through a very flat air duct below the front seats on the vehicle body of the motor vehicle. Such air ducts have a very large width in relation to the height, however, so that high flow losses occur due to such an air duct and, on the other hand, a strong heat transfer to the surroundings occurs because of the large surface area of the air duct.

For example, if the vehicle interior is to be heated in winter by the air duct below the front seats, the hot air conducted from the motor vehicle air conditioner below the dashboard between the front seats is cooled strongly until it flows out to the persons on the rear seats of the motor vehicle. This is also similarly true when cooling the motor vehicle in summer through the motor vehicle air conditioner. For this reason, it is necessary for the air duct for conducting air to the rear ventilation opening to have an essentially square, circular, or rectangular cross-section, a rectangular cross-section being understood to mean that the ratio between height and width is in the range between approximately 5 and approximately 0.2.

However, such air ducts for conducting air to the rear ventilation openings generally cannot be attached or integrated below the front seats on the vehicle body, but rather are to be installed in the center console between the two front seats. However, an air duct on the central console requires additional installation space, so that in particular in smaller motor vehicles, e.g., motor vehicles from the small car class or the compact car class, very little space is still available for storage compartments on the central console.

At least one object therefore comprises providing a motor vehicle, in which the volume of storage compartments on the central console can be adapted to the need for an optional rear ventilation opening. In addition, other objects, desirable features and characteristics will become apparent from the subsequent summary and detailed description, and the appended claims, taken in conjunction with the accompanying drawings and this background.

### SUMMARY

This object is achieved by a motor vehicle having a ventilation system, the ventilation system comprising at least one front ventilation opening for supplying air to a passenger on a front seat, at least one rear ventilation opening for supplying air to a passenger on a rear seat, and one air duct for conducting air to the rear ventilation opening, the air duct being situated between the front seats in the area of the central console, and the air duct being integrated in a removable central console part.

The air duct for conducting air from a motor vehicle air conditioner to a rear ventilation opening is integrated or installed in a removable central console part. The removable central console part is attached to the remaining motor vehicle or the remaining central console in an installed state and the central console part is not fastened or situated on the motor vehicle or the remaining central console in a removed state, i.e., it is not situated inside the vehicle interior of the motor vehicle. The removable central console part is therefore only an optional component on the motor vehicle. In the case of an installed central console part, air can thus be conducted through the air duct in the central console part to the rear ventilation opening and in the case of a removed central console part, air cannot be conducted to the rear ventilation opening, but additional space is available on the central console, so that the larger storage compartments for accommodating objects are available on the central console.

A flexible ventilation system is thus provided on the motor vehicle, in which, in the event of a demand for a rear ventilation opening, the central console part is attached to the remaining central console and air from the motor vehicle air conditioner can thus be conducted out of the rear ventilation opening. If such a rear ventilation opening is not desired or is not necessary, for example, because no persons are located on the rear seats of the motor vehicle, the central console part can be removed and larger storage compartments are thus available on the central console for accommodating objects. Therefore, in particular in the case of motor vehicles from the small car class or compact car class, the existing small amount of space within the motor vehicle between the front seats can thus advantageously be used optimally and adapted to the requirements for the motor vehicle. In particular, in the case of an installed central console part, the air can be conducted through the air duct to the rear ventilation opening.

In a further embodiment, in the case of a removed central console part, air cannot be conducted to the rear ventilation opening. In a supplementary embodiment, the central console part has at least one console part storage compartment for accommodating objects. The central console part preferably comprises multiple console part storage compartments, e.g., two, three, or four console part storage compartments. Additional fastening devices, e.g., cup holders or holding devices for other objects, and/or also closable storage compartments, e.g., having a flap or a roller blind, can also be situated on the console part storage compartments.

The central console preferably has at least one console storage compartment for accommodating objects in the case of the removed central console part. The central console preferably comprises multiple console storage compartments, e.g., two, three, or four console storage compartments. In the case of the removed central console part, in a similar way to the central console part, fastening devices can also be situated on the central console, e.g., cup holders or holding devices for other objects, and/or also closable storage compartments, e.g., having a flap or a roller blind.

In a variant, the volume of a console storage compartment or the sum of the volumes of the console storage compartment is greater, in particular approximately 1.1, approximately 1.5, or approximately 2 times greater, than the volume of the console part storage compartment or the sum of the volumes of the console part storage compartments.

The rear ventilation opening is expediently integrated in the central console part. Therefore, in the case of a removed central console part, no rear ventilation opening is advantageously provided on the motor vehicle, because the rear ventilation opening is attached to and integrated in the removable central console part.

In a further embodiment, the rear ventilation opening has air guiding elements for controlling the outflow direction of the air flowing out of the rear ventilation opening and/or the air duct on the central console part has an air flap for opening and closing the air duct, so that in the case of an installed central console part, the rear ventilation opening is closable and operable. The air flowing out of the rear ventilation opening can thus advantageously be controlled and/or regulated in its outflow direction by the occupants of the motor vehicle on the rear seats. Using an adjustment element, e.g., an adjustment lever or an adjustment knob, the air guiding elements can be moved and therefore the outflow direction of the air from the rear ventilation opening can be controlled. The air duct can additionally advantageously be open or closed using an air flap, so that the supply of air from the rear ventilation opening can thus be turned on and off. In particular, air can be conducted into the air duct in the case of an installed central console part through a supply opening, on the remaining motor vehicle outside the central console part.

In an additional embodiment, the supply opening is additionally also a front ventilation opening and is used to supply air to the occupants on the front seats in the removed state of the central console part. The supply opening is expediently situated between the front seats in the area of the central console and/or below the dashboard. In a further embodiment, the supply opening is provided with a closing device, so that the supply opening is closed in the case of a removed central console part. In an additional embodiment, the central console part at least partially, in particular completely comprises plastic, preferably thermoplastic elastic, and/or metal.

In a supplementary variant, the motor vehicle comprises a motor vehicle air conditioner having a heating device for heating the air to be supplied to the vehicle interior and/or a refrigerant vaporizer for cooling the air to be supplied to the vehicle interior.

In a further embodiment, the air duct has an essentially square, circular, or rectangular cross-section, in the case of a rectangular cross-section, the ratio between height and width being in the range between approximately 5 and approximately 0.2, in particular between approximately 2 and approximately 0.5.

In an additional embodiment, the central console part is removably connected to the motor vehicle and/or the central console by means of a form-fitting and/or friction-locked connection. In a supplementary variant, the central console part is removably connected to the motor vehicle and/or the central console by means of a catch, clip, and/or screw connection.

### BRIEF DESCRIPTION OF THE DRAWINGS

The present invention will hereinafter be described in conjunction with the following drawing figures, wherein like numerals denote like elements, and:

FIG. 1 shows a top view of an interior of a motor vehicle;

FIG. 2 shows a perspective view of a central console and a central console part;

FIG. 3 shows a perspective view of the central console part according to FIG. 2;

FIG. 4 shows a perspective view of the central console having the installed central console part; and

FIG. 5 shows a side view of a motor vehicle.

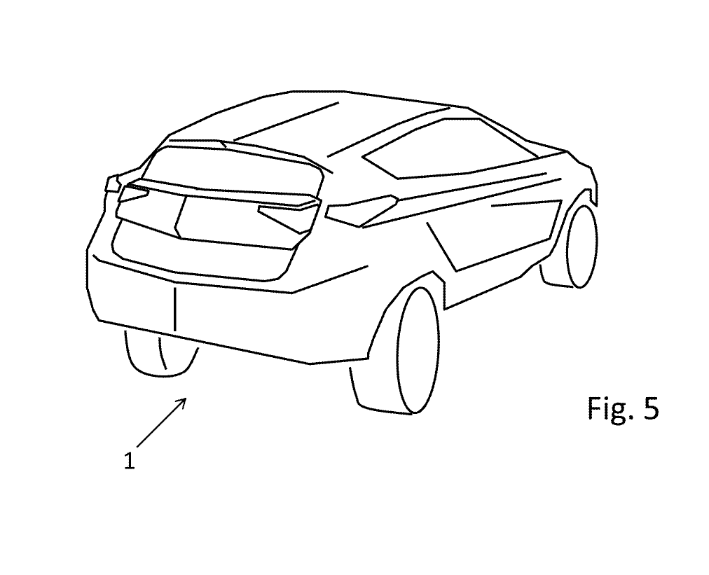

### DETAILED DESCRIPTION

The following detailed description is merely exemplary in nature and is not intended to limit application and uses. Furthermore, there is no intention to be bound by any theory presented in the preceding background or summary or the following detailed description.

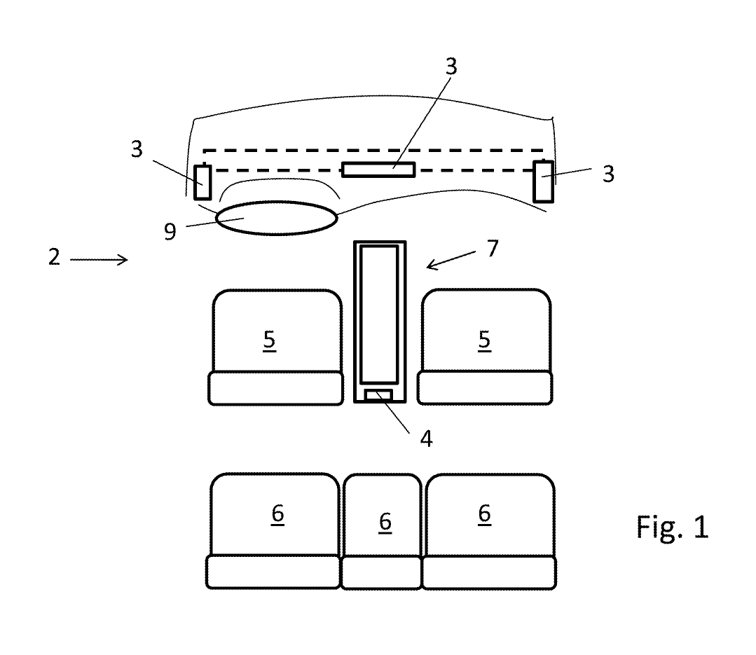

A motor vehicle 1 having an internal combustion engine, a hybrid drive device, or an electric motor is used to convey persons within the motor vehicle 1. The motor vehicle 1 has an interior. A greatly simplified top view of the interior is shown in FIG. 1. To supply air from the surroundings of the motor vehicle or to supply air in circulating air operation of air from the interior of the motor vehicle, air is introduced into the interior of the motor vehicle 1 by means of a ventilation system 2.

Two front seats 5 and three rear seats 6 are situated inside the interior of the motor vehicle 1. The three rear seats 6 are combined into a rear seat bench. Multiple front ventilation openings 3 are situated in the area of a dashboard 8 to supply air to persons on the front seats 5. The motor vehicle 1 has a rear ventilation opening 4 to supply air to persons on the rear seats 6. The rear ventilation opening 4 is situated behind the rear halves of the two front seats 5, preferably in the area of the end of the front seats 5 viewed in the transverse direction of the motor vehicle 1. The rear ventilation opening 4 is attached to a central console 7. A steering wheel 9 is used to control and guide the motor vehicle 1.

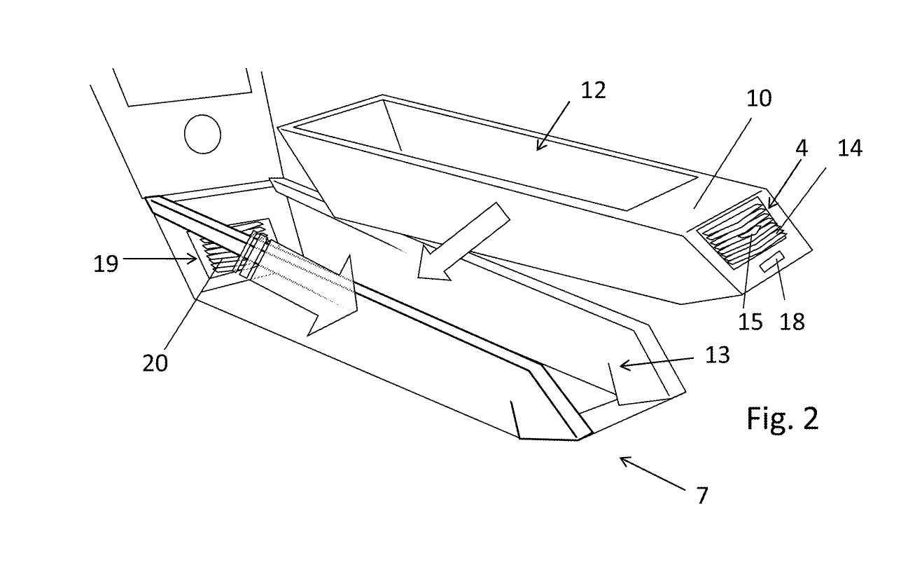

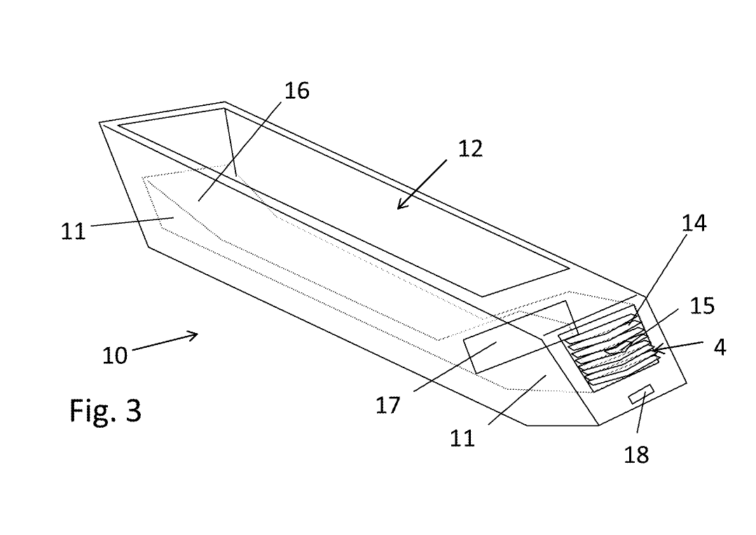

A central console part 10 (FIG. 2 to FIG. 4) having a console part storage compartment 12, is an optional component of the motor vehicle 1. The central console part 10 is part of the central console 7 and the central console 7 without the central console part 10 has a console storage compartment 13 (FIG. 2). The console storage compartment 13 and also the console part storage compartment 12 are used to accommodate at least one object 21, e.g., a cup, a book, or a mobile telephone.

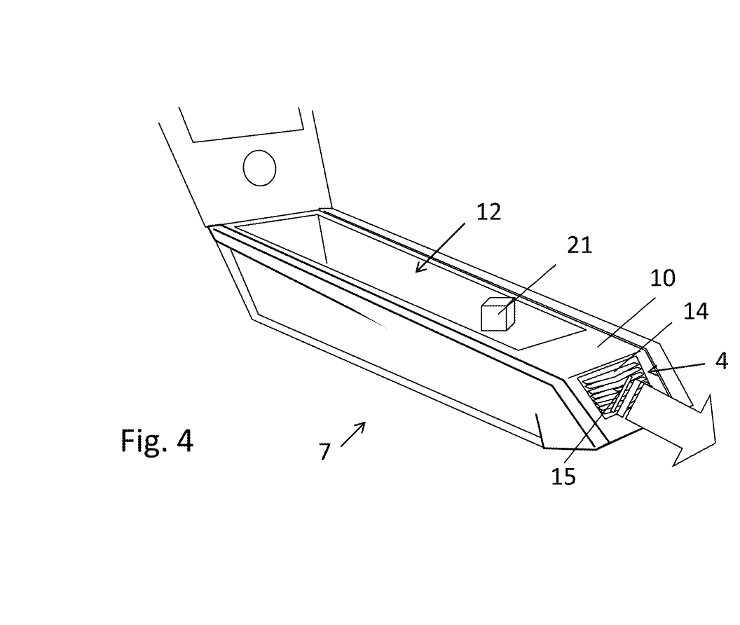

In FIG. 2, the central console 7 is shown before the installation of the central console part 10, i.e., in the case of a removed central console part 10, and in FIG. 4 the central console part 10 is installed on the remaining central console 7. The central console part 10 made of plastic has an air duct 11. Air can be introduced into the air duct 11 through an inlet opening 16 on the central console part 10 and the air can be conducted back out again through the rear ventilation opening 4, which is integrated in the central console part 10. Furthermore, air guiding elements 14, e.g., an air grid, are situated on the rear ventilation opening 4, which can be moved with the aid of an adjustment lever 15, so that the outflow direction of the air flowing out of the rear ventilation opening 4 on the central console part 10 can thus be controlled by the occupants on the rear seats 6. Furthermore, an air flap 17 is installed in the air duct 11, which can be moved by means of a flap adjustment lever 18, so that the supply of air into the vehicle interior through the rear ventilation opening 4 can thus be interrupted and opened.

A supply opening 19 is implemented in the area of the central console 7 below the dashboard 8. In the installed state of the central console part 10 shown in FIG. 4, the air from the motor vehicle air conditioner flows through the supply opening 19 into the air duct 11, subsequently flows through the air duct 11, and exits at the rear ventilation opening 4 in the area of the rear seats 6. In the installed state of the central console part 10, the supply opening 19 is sealed, for example, by means of a sealing element (not shown), so that the air exiting from the supply opening 19 is introduced completely into the air duct 11. Furthermore, a closing device 20, e.g., an air flap or a roller blind, is situated on the supply opening 19, so that in the removed state of the central console part 10 shown in FIG. 2, the supply opening 19 is closed. This is preferably implemented by means of a mechanism (not shown) in such a way that the closing device 20 is automatically opened when the central console part 10 is situated on the remaining central console 7 and the closing device 20 is automatically closed upon removal of the central console 7 from the remaining central console 7. This is preferably a failsafe device for opening and closing the closing device 20.

If a rear ventilation opening 4 is not required on the motor vehicle 1, for example, because no occupants are located on the rear seats 6, the central console part 10 can be removed from the remaining central console 7, so that a larger storage space or a larger volume is thus available for the accommodation of objects on the central console 7, since no installation space is required for the air duct 11 on the central console 7 and therefore the console storage compartment 13 can have a larger volume. However, if a rear ventilation opening 4 is desired by the operator of the motor vehicle 1, the central console part 10 can easily be removably connected using a connection mechanism (not shown) to the remaining central console 7, so that thus the rear ventilation opening 4 between the two front seats 5 in the area of the rear seats 6 is available for the passengers on the rear seats 6. The central console part 10 is securely and reliably connected to the remaining central console 7 using a catch or connection mechanism (not shown).

Considered as a whole, substantial advantages are connected with the motor vehicle 1 according to the invention. The available space on the central console 7 between the front seats 5 can be used optimally, because if a rear ventilation opening 4 is not required, the central console part 10 having the air duct 11 can be removed and thus a large console storage compartment 13 is available and, on the other hand, if a rear ventilation opening 4 is desired, an air duct 11 in a suitable cross-sectional shape is available, so that when the air is conducted from the motor vehicle air conditioner to the rear ventilation opening 4, only a slight temperature change occurs.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A motor vehicle having a ventilation system, the ventilation system comprising:
a front ventilation opening configured to supply air to a passenger front seat;
a rear ventilation opening configured to supply air to a passenger rear seat; and
an air duct configured to conduct air to the rear ventilation opening, the air duct situated between the passenger front seat in an area of a central console, the air duct integrated in a removable central console part.

2. The motor vehicle according to claim 1, wherein the air is conducted through the air duct to the rear ventilation opening in case of an installation of the removable central console part.

3. The motor vehicle according to claim 1, wherein air is not conducted to the rear ventilation opening in case of a removal of the removable central console part.

4. The motor vehicle according to claim 1, wherein the removable central console part has a storage compartment configured to accommodate an object.

5. The motor vehicle according to claim 1, wherein the central console comprises a console storage compartment that is configured to accommodate an object in case of a removal of the removable central console part.

6. The motor vehicle according to claim 5, wherein a volume of the console storage compartment is greater than a volume of the removable central console part.

7. The motor vehicle according to claim 4, wherein a sum of the volumes of console storage compartments is greater than the sum of the volumes of removable central console part storage compartments.

8. The motor vehicle according to claim 5, wherein the volume of the console storage compartment is approximately 1.1 greater than the volume of the removable central console part.

9. The motor vehicle according to claim 5, wherein the volume of the console storage compartment is approximately 1.5 greater than the volume of the removable central console part.

10. The motor vehicle according to claim 5, wherein the volume of the console storage compartment is approximately 2 greater than the volume of the removable central console part.

11. The motor vehicle according to claim 7, wherein the sum of the volumes of console storage compartments is approximately 1.1 greater than the sum of the volumes of removable central console part compartments.

12. The motor vehicle according to claim 7, wherein the sum of the volumes of console storage compartments is approximately 1.5 greater than the sum of the volumes of removable central console part compartments.

13. The motor vehicle according to claim 7, wherein the sum of the volumes of console storage compartments is approximately 2 greater than the sum of the volumes of removable central console part compartments.

14. The motor vehicle according to claim 1, wherein the rear ventilation opening comprises air guiding elements configured to control an outflow direction of an air flow out of the rear ventilation opening.

15. The motor vehicle according to claim 1, wherein the air duct on the removable central console part comprises an air flap configured to open and close the air duct.

16. The motor vehicle according to claim 1, wherein air is conducted into the air duct through a supply opening in case of an installed central console part.

17. The motor vehicle according to claim 16, wherein the supply opening is provided with a closing device that is configured to close the supply opening in case of a removed central console part.
